(19) United States
(12) Patent Application Publication
(10) Pub. No.: US 2017/0152000 A1
(43) Pub. Date: Jun. 1, 2017

(54) INTEGRATED POWER MODULE AND ELECTRIC BICYCLE HAVING THE SAME

(71) Applicant: Industrial Technology Research Institute, Hsin-Chu (TW)

(72) Inventors: CHIN-PIN CHIEN, Hsinchu County (TW); MIN-CHUAN WU, Hsinchu City (TW)

(21) Appl. No.: 14/985,713

(22) Filed: Dec. 31, 2015

(30) Foreign Application Priority Data
Dec. 1, 2015 (TW) 104140180

(51) Int. Cl. B62M 6/55; B62M 6/60; B62M 6/45; B60L 11/18

(52) U.S. Cl. CPC B62M 6/55; B60L 11/18; B62M 6/60; B62M 6/45

(57) ABSTRACT

An integrated power module is provided, which may include a power port, battery, controller, motor, and a connection element. The power port may include a first positive electrode terminal, second positive electrode terminal, and a negative electrode terminal. The positive electrode of the battery may be electrically coupled to one end of the first positive electrode terminal. The negative electrode of the controller may be electrically coupled to the negative electrode of the battery and one end of the negative electrode terminal; the positive electrode of the controller may be electrically coupled to one end of the second positive electrode terminal. The motor may be electrically coupled to the output of the controller. The connection element may include a single circuit; the other end of the first positive electrode terminal may be electrically coupled to the other end of the second positive electrode terminal via the single circuit.

### CROSS REFERENCE TO RELATED APPLICATION

All related applications are incorporated by reference. The present application is based on, and claims priority from, Taiwan Application Serial Number 104140180, filed on Dec. 1, 2015, the disclosure of which is hereby incorporated by reference herein in its entirety.

### TECHNICAL FIELD

The technical field relates to a power module, in particular to an integrated power module applicable to electric bicycle. The technical field further related to an electronic bicycle having the integrated power module.

### BACKGROUND

In general, a conventional bicycle needs to be driven by manpower; however, the physical strength of the user constrains the driving distance of the conventional bicycle. Accordingly, power assistant bicycle is developed to solve the above problem; a power assistant bicycle can provide assistant power, so its driving distance can be effectively extended; in addition, the power assistant bicycle will not generate waste gas to result in air pollution; therefore, the impact to environment can be reduced; for the reason, the power assistant bicycle has become one of the alternatives of petrol vehicle. Moreover, many countries all are facing an accelerating trend of population aging and the advantages of the power assistant bicycle are just very suitable for the elder; thus, the power assistant bicycle has become one of the most popular vehicles. For the above reasons, it has become a trend in the future to develop the power assistant bicycle.

Generally speaking, the driving system of a conventional power assistant bicycle is composed of a motor, a controller and a battery, etc., and each of the above components is independent, which will significantly influence the design and visual aesthetics of the conventional bicycle frame; accordingly, integrated power module is developed to integrate all components of the driving system, including motor, battery and controller, into one. Currently, many different kinds of integrated power modules with different designs have been developed; for example, U.S. Pat. No. 9,027,681 provides an in-wheel power module. However, the range will be limited due to the limited battery capacity in the integrated power module. For the range extension, China Patent Application No. 200945896 provides a conventional power assistant bicycle with two batteries; China Patent Application No. 20282797U provides a power assistant bicycle with backup battery. However, these currently designs all need an additional battery input port besides the charging port, or an additional switch.

### SUMMARY

One of the primary objects of the present disclosure is to provide an integrated power module and the electric bicycle having the same in order to solve the problems that conventional integrated power modules are of short driving range, poor expandability, and high cost and complexity for range extension.

An integrated power module is provided, which may include a power port, a battery, a controller, a motor, and a connection element. The power port may include a first positive electrode terminal, a second positive electrode terminal, and a negative electrode terminal. The positive electrode of the battery may be electrically coupled to one end of the first positive electrode terminal. The negative electrode of the controller may be electrically coupled to the negative electrode of the battery and one end of the negative electrode terminal; the positive electrode of the controller may be electrically coupled to one end of the second positive electrode terminal. The motor may be electrically coupled to the output of the controller. The connection element may include a single circuit; the other end of the first positive electrode terminal may be electrically coupled to the other end of the second positive electrode terminal via the single circuit.

An electric bicycle is provided, which may include a bicycle body and an integrated power module; the integrated power module may include a power port, a battery, a controller, a motor, and a connection element. The power port may include a first positive electrode terminal, a second positive electrode terminal, and a negative electrode terminal. The positive electrode of the battery may be electrically coupled to one end of the first positive electrode terminal. The negative electrode of the controller may be electrically coupled to the negative electrode of the battery and one end of the negative electrode terminal; the positive electrode of the controller may be electrically coupled to one end of the second positive electrode terminal. The motor may be electrically coupled to the output of the controller. The connection element may include a single circuit; the other end of the first positive electrode terminal may be electrically coupled to the other end of the second positive electrode terminal via the single circuit.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a first schematic view of an integrated power module of the first embodiment of the present disclosure.

FIG. 2 is a second schematic view of an integrated power module of the first embodiment of the present disclosure.

FIG. 3 is a third schematic view of an integrated power module of the first embodiment of the present disclosure.

FIG. 4 is a fourth schematic view of an integrated power module of the first embodiment of the present disclosure.

FIG. 5 is a first schematic view of an integrated power module of the second embodiment of the present disclosure.

FIG. 6 is a second schematic view of an integrated power module of the second embodiment of the present disclosure.

FIG. 7 is a third schematic view of an integrated power module of the second embodiment of the present disclosure.

FIG. 8 is a fourth schematic view of an integrated power module of the second embodiment of the present disclosure.

FIG. 9A is a first schematic view of an integrated power module of the third embodiment of the present disclosure.

FIG. 9B is a second schematic view of an integrated power module of the third embodiment of the present disclosure.

FIG. 10A is a third schematic view of an integrated power module of the third embodiment of the present disclosure.

FIG. 10B is a fourth schematic view of an integrated power module of the third embodiment of the present disclosure.

FIG. 11 is a fifth schematic view of an integrated power module of the third embodiment of the present disclosure.

FIG. 12 is a schematic view of an integrated power module of the fourth embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

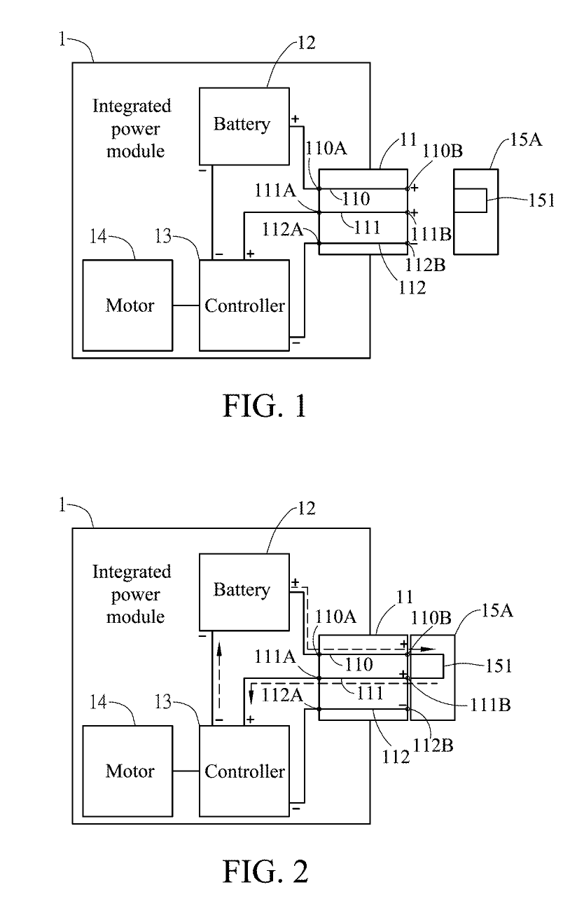

With reference to FIG. 1 and FIG. 2 for a first schematic view and a second schematic view of the first embodiment of the present disclosure. As shown in FIG. 1, the integrated power module 1 may include a power port 11, a battery 12, a controller 13, a motor 14 and a connection element 15A.

The power port 11 may include a first positive electrode terminal 110, a second positive electrode terminal 111 and a negative electrode terminal 112. The positive electrode of the battery 12 may be electrically coupled to one end 110A (the inner end) of the first positive electrode terminal 110. The negative electrode of the controller 13 may be electrically coupled to the negative electrode of the battery 12 and one end 112A (the inner end) of the negative electrode terminal 112; the positive electrode of the controller 13 may be electrically coupled to one end 111A (the inner end) of the second positive electrode terminal 111. The motor 14 may be electrically coupled to the controller 13. In the embodiment, the connection element 15A may be a port cap, which may detachably cap the power port 11; besides, the connection element 15A may include a single circuit 151.

FIG. 2 illustrates the schematic view of the internal power supply mode of the integrated power module 1. As shown in FIG. 2, when the user wants to execute the internal power supply mode to supply power to the controller 13 via the battery 12 built in the integrated power module 1 so as to drive the motor 14, the user can cap the power port 11 with the connection element 15A; at this time, the other end 110B (the outer end) of the first positive electrode terminal 110 may be electrically coupled to the other end 111B (the outer end) of the second positive electrode terminal 111 via the single circuit 151 to form a loop; the power supply direction is as shown by the arrows in FIG. 2. In this way, the built-in battery 12 of the integrated power module 1 can supply power to the controller 13 to drive the motor 14.

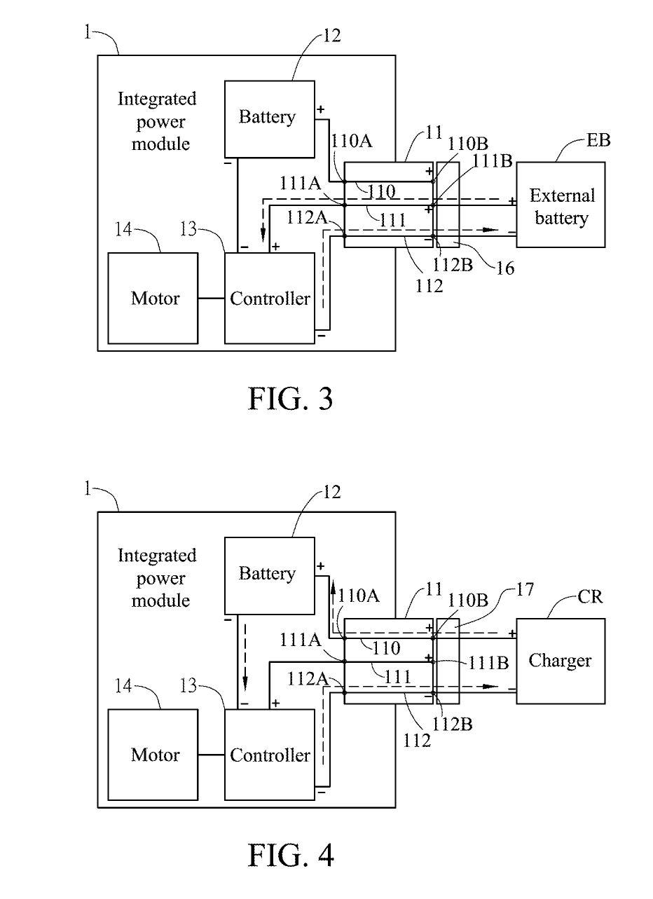

With reference to FIG. 3 and FIG. 4 for a third schematic view and a fourth schematic view of the first embodiment of the present disclosure. FIG. 3 illustrates the schematic view of the external power supply mode of the integrated power module 1. As shown in FIG. 3, when the built-in battery is exhausted after the electric bicycle travels for a certain distance and the user wants to use the external battery EB to supply power to the controller 13 to drive the motor 14, the user may remove the connection element 15A from the power port 11; then, the user may couple the other end 111B of the second positive electrode terminal 111 to the positive electrode of the external battery EB, and couple the other end 112B (the outer end) of the negative electrode terminal 112 to the negative electrode of the external battery EB via the external battery connector 16 so as to form a loop; the power supply direction is as shown by the arrows in FIG. 3. In this way, the integrated power module 1 may supply power to the controller 13 via the external battery EB to drive the motor 14.

FIG. 4 illustrates the schematic view of the charge mode of the integrated power module 1. As shown in FIG. 4, when the user wants to charge the built-in battery 12 of the integrated power module 1, the user can remove the connection element 15A from the power port 11; then, the user can couple the other end 110B (the outer end) of the first positive electrode terminal 110 to the positive electrode of the charger CR, and couple the other end 112B (the outer end) of the negative electrode terminal 112 to the negative electrode of the charger CR via the charger connector 17 so as to form a loop; the power supply direction is as shown by the arrows in FIG. 4. In this way, the integrated power module 1 can charge the battery 12 via the external charger CR.

As described above, by means of the special circuit design and the connection element 15A, the integrated power module 1 can execute three different modes, internal power supply mode, external power supply mode and charge mode, only by the power port with two positive electrode terminal 110, 111 and one negative electrode terminal 112 rather than additional battery port, charger port, detection circuit or switch circuit; accordingly, the integrated power module 1 can be of high expandability and more flexible in use. Therefore, the integrated power module 1 is very suitable for various electric bicycle.

It is worthy to point out that the capacity of the built-in battery of a conventional integrated power module is not enough for an electric bicycle to travel for a long distance. On the contrary, according to one embodiment of the present disclosure, the integrated power module can not only supply the power to the electric bicycle via a built-in battery, but also can directly couple to an external battery; in this way, the integrated power module can provide sufficient power for the electric bicycle to travel a long distance; therefore, the driving range of the electric bicycle can be further extended.

Besides, the conventional integrated power module has no expansion function, so its power port can only be connected to a charger; therefore, the expandability of the conventional integrated power module is low and limited in function. On the other hand, the conventional integrated power module needs to connect to an external battery via an additional battery port or an additional detection circuit/switch circuit, which will significantly increase the cost of the conventional integrated power module. On the contrary, according to one embodiment of the present disclosure, by means of the special circuit design, the integrated power module may only need two positive electrode terminals and one negative electrode terminal to execute at least three different modes (internal power supply mode, external power supply mode and charge mode) without additional battery port, charger port, detection circuit or switch circuit; therefore, the quantity of the ports of the integrated power module can be minimized, so the cost of the integrated power module can be significantly reduced.

Furthermore, according to one embodiment of the present disclosure, the integrated power module may include a port cap; when the power port is capped by the port cap, the integrated power module can execute the internal power supply mode; in addition, the port cap can also achieve dust-proof and water proof effects to protect the power port when the power port is capped by the port cap; therefore, the failure rate of the integrated power module can be reduced and its service life can be longer. As describe above, the present disclosure definitely has an inventive step.

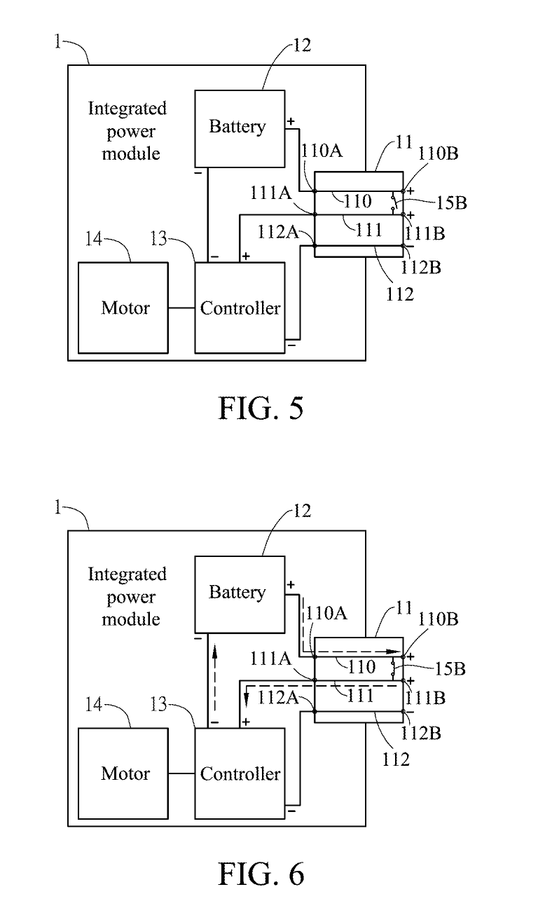

With reference to FIG. 5 and FIG. 6 for a first schematic view and a second schematic view of the second embodiment of the present disclosure. As shown in FIG. 5, the integrated power module 1 may include a power port 11, a battery 12, a controller 13, a motor 14 and a connection element 15B.

The power port 11 may include a first positive electrode terminal 110, a second positive electrode terminal 111 and a negative electrode terminal 112. The positive electrode of the battery 12 may be electrically coupled to one end 110A (the inner end) of the first positive electrode terminal 110. The negative electrode of the controller 13 may be electrically coupled to the negative electrode of the battery 12 and one end 112A (the inner end) of the negative electrode terminal 112; the positive electrode of the controller 13 may be electrically coupled to one end 111A (the inner end) of the second positive electrode terminal 111. The motor 14 may be electrically coupled to the controller 13. The difference between the embodiment and the previous embodiment is that the connection element 15B may be an internal switch installed inside the power port 11; the connection element 15B may be turned on to electrically couple the other end 110B (the outer end) of the first positive electrode terminal 110 to the other end 111B (the outer end) of the second positive electrode terminal 111, or turned off to cut off the electrical connection between the other end 110B (the outer end) of the first positive electrode terminal 110 and the other end 111B (the outer end) of the second positive electrode terminal 111.

FIG. 6 illustrates the schematic view of the internal power supply mode of the integrated power module 1. As shown in FIG. 6, when the user wants to execute the internal power supply mode, the user can switch on the connection element 15B to electrically couple the other end 110B (the outer end) of the first positive electrode terminal 110 to the other end 111B (the outer end) of the second positive electrode terminal 111; at this time, the other end 110B (the outer end) of the first positive electrode terminal 110 can be electrically coupled to the other end 111B (the outer end) of the second positive electrode terminal 111 to form a loop; the power supply direction is as shown by the arrows in FIG. 6. In this way, the built-in battery 12 of the integrated power module 1 can supply power to the controller 13 to drive the motor 14.

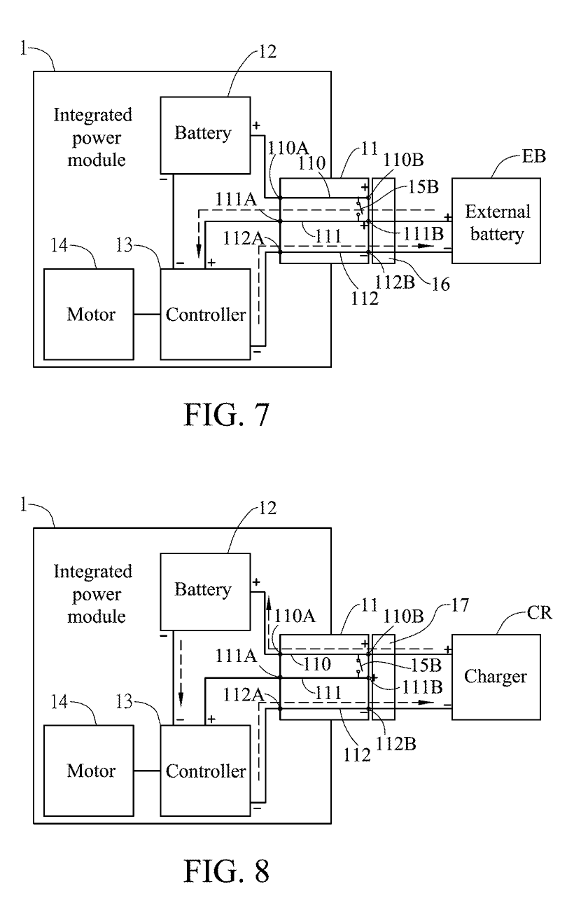

With reference to FIG. 7 and FIG. 8 for a third schematic view and a fourth schematic view of the second embodiment of the present disclosure. FIG. 7 illustrates the schematic view of the external power supply mode of the integrated power module 1. As shown in FIG. 7, when the user wants to supply power to the controller 13 to drive the motor 14 via an external battery EB, the user can switch off the connection element 15B to cut off the electrical connection between the other end 110B (the outer end) of the first positive electrode terminal 110 and the other end 111B (the outer end) of the second positive electrode terminal 111; then, the user can electrically couple the other end 111B (the outer end) of the second positive electrode terminal 111 to the positive electrode of the external battery EB, and electrically couple the other end 112B (the outer end) of the negative electrode terminal 112 to the negative electrode of the external battery EB via an external battery connector 16 to form a loop; the power supply direction is as shown by the arrows in FIG. 7. In this way, the integrated power module 1 may supply power to the controller 13 via the external battery EB to drive the motor 14.

FIG. 8 illustrates the schematic view of the charge mode of the integrated power module 1. As shown in FIG. 8, when the user wants to charge the built-in battery 12 of the integrated power module 1, the user can switch off the connection element 15B to cut off the electrical connection between the other end 110B (the outer end) of the first positive electrode terminal 110 and the other end 111B (the outer end) of the second positive electrode terminal 111; then, the user can electrically couple the other end 110B (the outer end) of the first positive electrode terminal 110 to the positive electrode of the charger CR, and electrically couple the other end 112B (the outer end) of the negative electrode terminal 112 to the negative electrode of the charger CR to form a loop; the power supply direction is as shown by the arrows in FIG. 8. In this way, the integrated power module 1 can charge the battery 12 via the external charger CR.

As described above, by means of the special circuit design and the connection element 15B, the integrated power module 1 can execute three different modes, internal power supply mode, external power supply mode and charge mode, only by the power port with two positive electrode terminal 110, 111 and one negative electrode terminal 112 rather than additional battery port, charger port, detection circuit or switch circuit; accordingly, the integrated power module 1 can be of high expandability and more flexible in use.

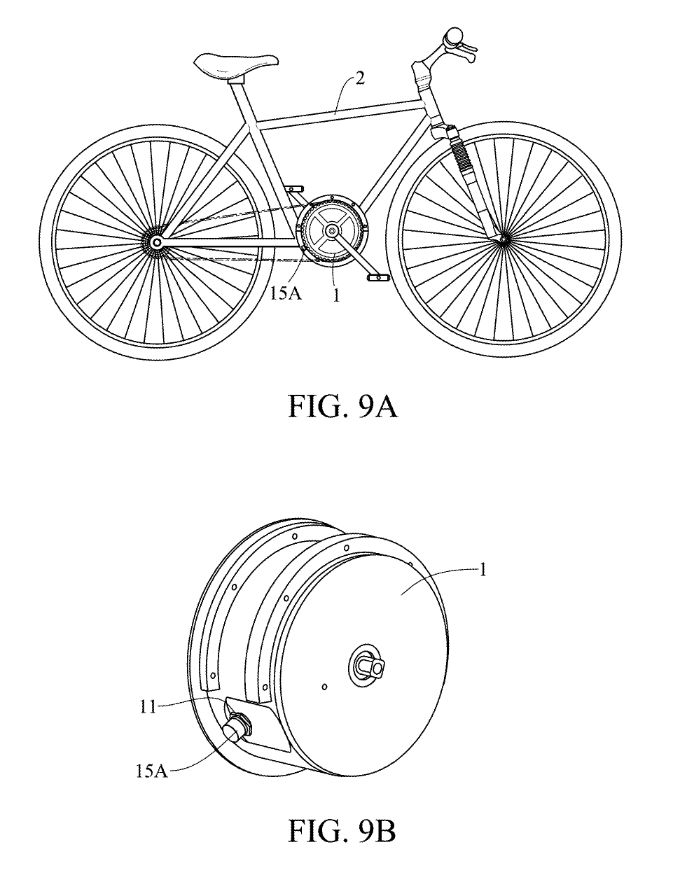

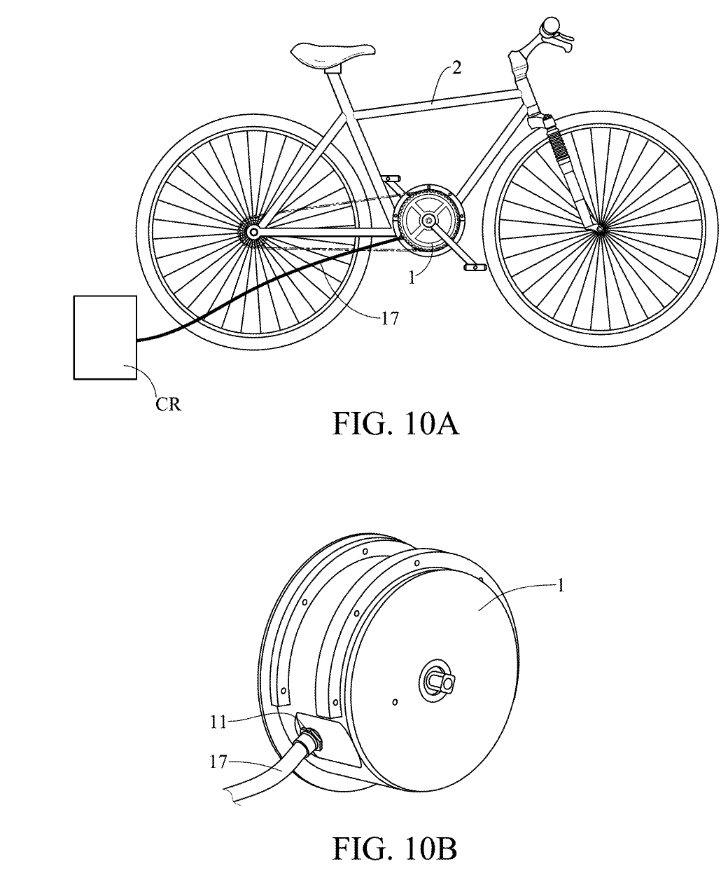

With reference to FIG. 9A, FIG. 9B, FIG. 10A and FIG. 10B for a first schematic view, a second schematic view, a third schematic view and a fourth schematic view of the third embodiment of the present disclosure. The embodiment illustrates the usage situations of the integrated power module according to the embodiment of the present disclosure.

As shown in FIG. 9A, the integrated power module 1 may be mounted on an electric bicycle 2 and integrated with the crank shaft of the electric bicycle 2, which is the middle-mounted type design.

As shown in FIG. 9B, when the user wants to execute the internal power supply mode, the user can cap the power port 11 of the integrated power module 1 by the connection element 15A (port cap) to electrically couple the first positive electrode terminal to the second positive electrode terminal of the integrated power module 1; in this way, the controller of the integrated power module 1 can be charged by the built-in battery of the integrated power module 1.

As shown in FIG. 10A, after the built-in battery of the integrated power module 1 is exhausted, the user needs to execute the charge mode; then, the user may directly couple the power port 11 to a charger.

As shown in FIG. 10B, the user can remove the connection element 15A (port cap) from the power port 11; afterward, the user can electrically couple the first positive electrode terminal of the integrated power module 1 to the positive electrode of the charger CR, and electrically couple to the negative electrode of the integrated power module 1 to the negative electrode of the charger CR via a charger connector 17; in this way, the built-in battery of the integrated power module 1 can be charged by the external charger CR.

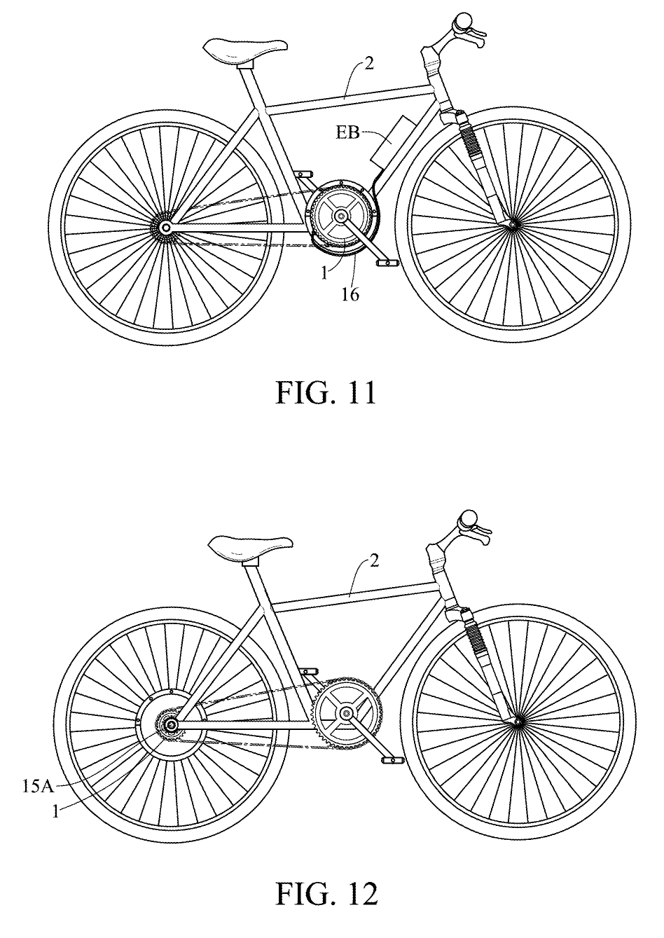

As shown in FIG. 11, when the user wants to ride the electric bicycle 2 to travel for a long distance, the user can couple the integrated power module 1 to an external battery EB. The user can electrically couple the second positive electrode terminal of the integrated power module 1 to the positive electrode of the external battery EB, and electrically couple to negative electrode of the integrated power module 1 to the negative electrode of the external battery EB; in this way, the integrated power module 1 can supply more power to the electric bicycle 2.

With reference to FIG. 12 for a schematic view of the fourth embodiment of the present disclosure. The embodiment illustrates a usage situation of the integrated power module according to the embodiment of the present disclosure.

As shown in FIG. 12, the integrated power module 1 may be mounted on an electric bicycle 2 and integrated with the wheel hub of the electric bicycle 2, which is the wheel-hub type design. However, the above structures are just for examples instead of limitations; the integrated power module 1 may be integrated with other parts of the bicycle body; the present disclosure will not be limited thereby.

In summation of the description above, the integrated power module and the bicycle having the same according to the exemplary embodiments of the present disclosure may have the following advantages:

(1) According to one embodiment of the present disclosure, the integrated power module can not only supply the power to the electric bicycle via a built-in battery, but also can directly connect to an external battery; in this way, the integrated power module can provide sufficient power for the electric bicycle to travel long distances; therefore, the driving range of the electric bicycle can be further extended.

(2) According to one embodiment of the present disclosure, the integrated power module may have two positive electrode terminals and one negative electrode terminal; besides, the circuit of the integrated power module is of special design; therefore, the integrated power module can not only supply power to the electric bicycle via the built-in battery, but also can directly connect to an external battery or charger without the need to install additional connectors on the integrated power module; accordingly, the integrated power module can perform at least three power supply modes, so the integrated power module is of high expandability and more flexible in use.

(3) According to one embodiment of the present disclosure, the integrated power module may have two positive electrode terminals and one negative electrode terminal; besides, the circuit of the integrated power module is specially designed, which allows the integrated power module to directly connect to an external battery or charger; therefore, the quantity of the connectors of the integrated power module can be minimized, so the cost of the integrated power module can be significantly reduced.

(4) According to one embodiment of the present disclosure, the integrated power module may include a port cap; when the power port is capped by the port cap, the integrated power module can execute the internal power supply mode; in addition, the port cap can also achieve dust-proof and water proof effects to protect the power port when the power port is capped by the port cap; therefore, the failure rate of the integrated power module can be reduced and its service life can be longer.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An integrated power module applicable to an electronic bicycle, comprising:
a power port, comprising a first positive electrode terminal, a second positive electrode terminal and a negative electrode terminal;
a battery, a positive electrode of said battery electrically coupled to one end of said first positive electrode terminal;
a controller, a negative electrode of said controller electrically coupled to a negative electrode of said battery and one end of said negative electrode terminal; a positive electrode of said controller electrically coupled to one end of said second positive electrode terminal;
a motor, electrically coupled to an output of said controller and outputting a driving force; and
a connection element, comprising a single circuit; the other end of said first positive electrode terminal may be electrically coupled to the other end of said second positive electrode terminal via said single circuit.

2. The integrated power module of claim 1, wherein said connection element is a port cap detachably caps said power port.

3. The integrated power module of claim 1, wherein said connection element is an internal switch disposed inside said power port; said internal switch is turned on to electrically couple the other end of said first positive electrode terminal to the other end of said second positive electrode terminal, or turned off to cut off an electrical connection between the other end of said first positive electrode terminal and the other end of said second positive electrode terminal.

4. The integrated power module of claim 1, wherein said power port is coupled to an external battery via an external battery connector, wherein the other end of said second positive electrode terminal is electrically coupled a positive electrode of said external battery, and the other end of said negative electrode terminal is electrically coupled to a negative electrode of said external battery.

5. The integrated power module of claim 1, wherein said power port is electrically coupled to a charger via a charger connector, wherein the other end of said first positive electrode terminal is electrically coupled a positive electrode of said charger, and the other end of said first positive electrode terminal is electrically coupled to a negative electrode of said charger.

6. The integrated power module of claim 1, wherein the integrated power module is integrated with a crank shaft of said electric bicycle.

7. The integrated power module of claim 1, wherein the integrated power module is integrated with a wheel hub of said electric bicycle.

8. An electric bicycle, comprising a bicycle body and an integrated power module, and said integrated power module comprising:
a power port, comprising a first positive electrode terminal, a second positive electrode terminal and a negative electrode terminal;
a battery, a positive electrode of said battery electrically coupled to one end of said first positive electrode terminal;
a controller, a negative electrode of said controller electrically coupled to a negative electrode of said battery and one end of said negative electrode terminal; a positive electrode of said controller electrically coupled to one end of said second positive electrode terminal;
a motor, electrically coupled to an output of said controller and outputting a driving force and
a connection element, comprising a single circuit; the other end of said first positive electrode terminal may be electrically coupled to the other end of said second positive electrode terminal via said single circuit.

9. The electric bicycle of claim 8, wherein said connection element is a port cap detachably caps said power port.

10. The electric bicycle of claim 8, wherein said connection element is an internal switch disposed inside said power port; said internal switch is turned on to electrically couple the other end of said first positive electrode terminal to the other end of said second positive electrode terminal, or turned off to cut off an electrical connection between the other end of said first positive electrode terminal and the other end of said second positive electrode terminal.

11. The electric bicycle of claim 8, wherein said power port is coupled to an external battery via an external battery connector, wherein the other end of said second positive electrode terminal is electrically coupled a positive electrode of said external battery, and the other end of said negative electrode terminal is electrically coupled to a negative electrode of said external battery.

12. The electric bicycle of claim 8, wherein said power port is electrically coupled to a charger via a charger connector, wherein the other end of said first positive electrode terminal is electrically coupled a positive electrode of said charger, and the other end of said first positive electrode terminal is electrically coupled to a negative electrode of said charger.

13. The electric bicycle of claim 8, wherein said bicycle body comprises a crank shaft and said integrated power module is integrated with said crank shaft.

14. The electric bicycle of claim 8, wherein said bicycle body comprises a wheel hub and said integrated power module is integrated with said wheel hub.
